(19) United States
(12) Patent Application Publication
(10) Pub. No.: US 2008/0114767 A1
(43) Pub. Date: May 15, 2008

(54) Trading Files Via Locking and Unlocking

(76) Inventors: Zachary Adam Garbow, Rochester, MN (US); Kevin Glynn Paterson, San Antonio, TX (US); Richard Michael Theis, Sauk Rapids, MN (US); Brian Paul Wallenfelt, Eden Prairie, MN (US)

Correspondence Address: IBM CORPORATION;ROCHESTER IP LAW DEPT. 917, 3605 HIGHWAY 52 NORTH, ROCHESTER, MN, 55901-7829, US

(21) Appl. No.: 11/558,544

(22) Filed: Nov. 10, 2006

(51) Int. Cl. G06F 17/30

(52) U.S. Cl. 707/9; 707/E17.005; 707/E17.032

(57) ABSTRACT

In an embodiment, clients create trade profiles that specify trade criteria. In various embodiments, the trade criteria specify categories of files that are desired, specify files that are desired, or specify files that are available to trade. The clients send the trade profiles to a server, which selects available files that meet the trade criteria of other clients. The server sends a specification of the selected files to the clients. In response, the clients lock their files, which prevents presentation and send the locked files to each other. The clients receive the locked files and unlock them. After expiration of a time period, the clients once again lock the files. In this way, a file may be traded by clients, but only one client may access the file at any one time.

### FIELD

An embodiment of the invention generally relates to computer systems and more specifically relates to trading files between computer systems.

### BACKGROUND

Years ago, computer systems were stand-alone devices that did not communicate with each other. But, today computers are increasing connected together via networks, where computers called clients retrieve information from other computers called servers. Some uses of these networks are for the sharing or trading of files, such as files that contain music or movies.

File sharing usually follows a peer-to-peer (P2P) model, where the files are stored on and served by the computers of the user clients that share the files. In file sharing, a centralized server usually stores a file list of the various files that are available at the various host clients. The requesting clients send searches to the centralized server that specify the files that they desire, e.g., a particular song, video, or movie. The server then sends a list to the requesting client of which host clients contain the desired file and facilitates the connection between the clients and the subsequent download of the file from the host client to the requesting client.

A variant of file sharing is called file trading, in which the server provides incentives for clients to become host clients, such as requiring clients to become hosts for the files that they have downloaded or by giving credits for hosting files, which the clients may use in exchange for the right to download other files. Although “file trading” uses the word “trade,” a copy of the file that is “traded” is physically present and capable of being used, accessed, or viewed at both the requesting client and the host client simultaneously. In practice, many of the files shared on file sharing and file trading networks are copyrighted music and movies. Making copies and “sharing” or “trading” these copies without authorization from the copyright holder is illegal in many countries.

What is needed is a technique that addresses the needs of both the copyright owners and the users who desire to share the files.

### SUMMARY

A method, apparatus, system, and storage medium are provided. In an embodiment, clients create trade profiles that specify trade criteria. In various embodiments, the trade criteria specify categories of files that are desired, specify files that are desired, or specify files that are available to trade. The clients send the trade profiles to a server, which selects available files that meet the trade criteria of other clients. The server sends a specification of the selected files to the clients. In response, the clients lock their files, which prevents presentation and send the locked files to each other. The clients receive the locked files and unlock them. After expiration of a time period, the clients once again lock the files. In this way, a file may be traded by clients, but only one client may access the file at any one time.

### BRIEF DESCRIPTION OF THE DRAWINGS

Various embodiments of the present invention are hereinafter described in conjunction with the appended drawings:

FIG. 1 depicts a high-level block diagram of an example system for implementing an embodiment of the invention.

FIG. 2 depicts a high-level block diagram of selected components of the example system, according to an embodiment of the invention.

FIGS. 3A, 3B, 3C, 3D, and 3E depict block diagrams of an example trade of files between two client devices in chronological order, according to an embodiment of the invention.

FIGS. 4A, 4B, 4C, 4D, and 4E depict block diagrams of an example trade of files between three client devices in chronological order, according to an embodiment of the invention.

FIGS. 5A and 5B depict block diagrams of example data structures for trade profiles, according to an embodiment of the invention.

FIGS. 6A, 6B, and 6C depict block diagrams of example data structures for transaction data, according to an embodiment of the invention.

FIG. 7 depicts a flowchart of example processing for trading files, according to an embodiment of the invention.

It is to be noted, however, that the appended drawings illustrate only example embodiments of the invention, and are therefore not considered limiting of its scope, for the invention may admit to other equally effective embodiments.

### DETAILED DESCRIPTION

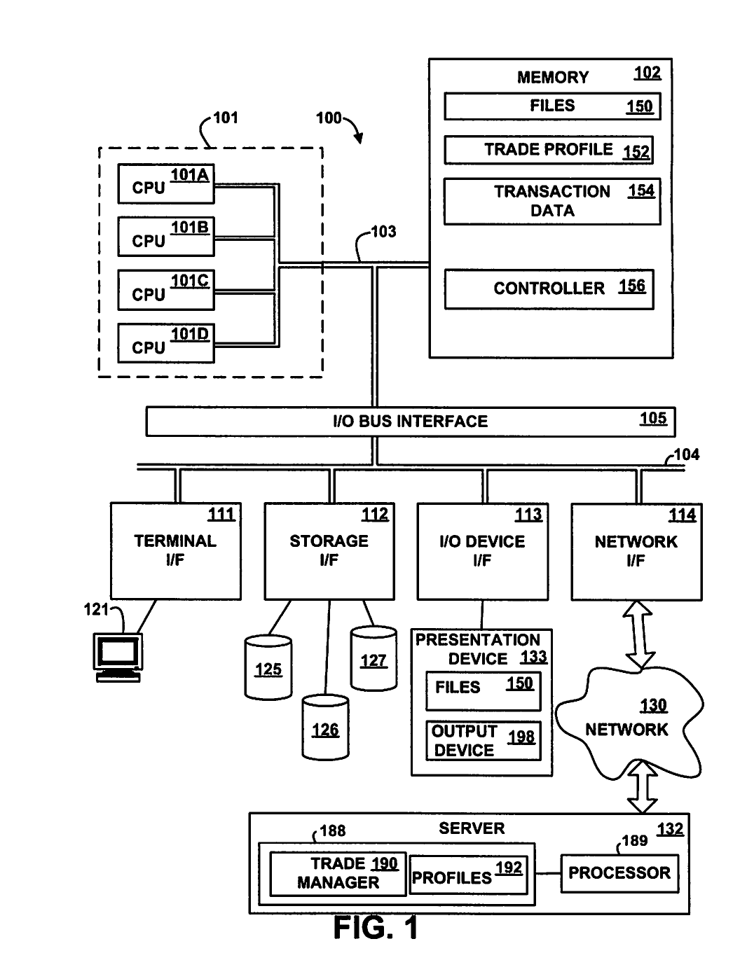

Referring to the Drawings, wherein like numbers denote like parts throughout the several views, FIG. 1 depicts a high-level block diagram representation of a client computer system 100 connected to a server computer system 132 via a network 130, according to an embodiment of the present invention. The terms “client” and “server” are used herein for convenience only, and in various embodiments a computer that operates as a client in one environment may operate as a server in another environment, and vice versa. The client computer system 100 is further connected to a presentation device 133. In an embodiment, the hardware components of the computer systems 100 and 132 may be implemented by an IBM System i5 computer system available from International Business Machines Corporation of Armonk, N.Y. However, those skilled in the art will appreciate that the mechanisms and apparatus of embodiments of the present invention apply equally to any appropriate computing system.

The major components of the computer system 100 include one or more processors 101, a main memory 102, a terminal interface 111, a storage interface 112, an I/O (Input/Output) device interface 113, and communications/network interfaces 114, all of which are coupled for inter-component communication via a memory bus 103, an I/O bus 104, and an I/O bus interface unit 105.

The computer system 100 contains one or more general-purpose programmable central processing units (CPUs) 101A, 101B, 101C, and 101D, herein generically referred to as the processor 101. In an embodiment, the computer system 100 contains multiple processors typical of a relatively large system; however, in another embodiment the computer system 100 may alternatively be a single CPU system. Each processor 101 executes instructions stored in the main memory 102 and may include one or more levels of on-board cache.

The main memory 102 is a random-access semiconductor memory or other storage device or devices for storing or encoding data and programs. In another embodiment, the main memory 102 represents the entire virtual memory of the computer system 100, and may also include the virtual memory of other computer systems coupled to the computer system 100 or connected via the network 130. The main memory 102 is conceptually a single monolithic entity, but in other embodiments the main memory 102 is a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may be further distributed and associated with different CPUs or sets of CPUs, as is known in any of various so-called non-uniform memory access (NUMA) computer architectures.

The main memory 102 stores or encodes files 150, a trade profile 152, transaction data 154, and a controller 156. Although the files 150, the trade profile 152, the transaction data 154, and the controller 156 are illustrated as being contained within the memory 102 in the computer system 100, in other embodiments some or all of them may be on different computer systems and may be accessed remotely, e.g., via the network 130. The computer system 100 may use virtual addressing mechanisms that allow the programs of the computer system 100 to behave as if they only have access to a large, single storage entity instead of access to multiple, smaller storage entities. Thus, while the files 150, the trade profile 152, the transaction data 154, and the controller 156 are illustrated as being contained within the main memory 102, these elements are not necessarily all completely contained in the same storage device at the same time. Further, although the files 150, the trade profile 152, the transaction data 154, and the controller 156 are illustrated as being separate entities, in other embodiments some of them, portions of some of them, or all of them may be packaged together.

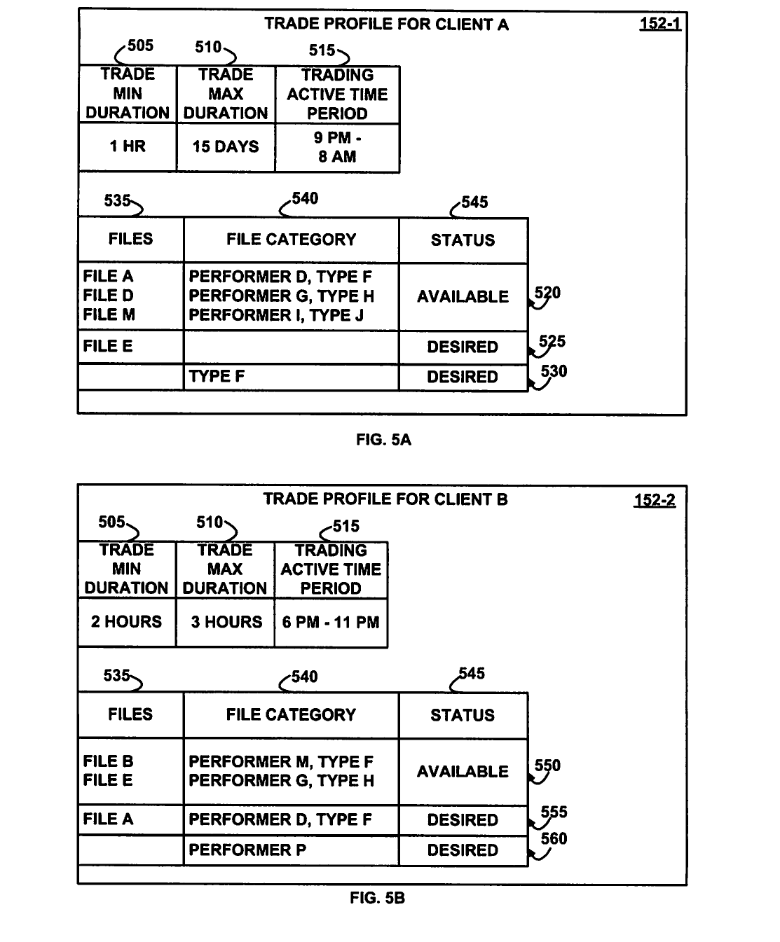

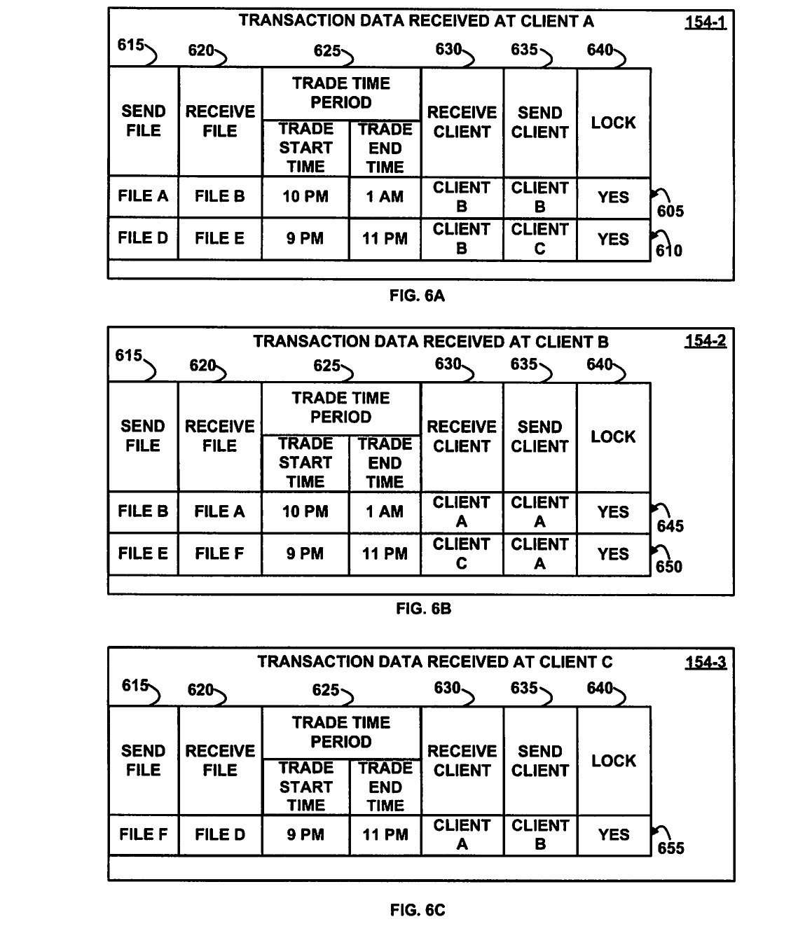

In various embodiments, the files 150 may store audio and/or video data capable of being presented or played via a speaker or video display. The trade profile 152 describes the files 150 that the user associated with the trade profile 152 desires to give in trade and the files 150 that the user desires to receive in trade. The client computer system 100 sends the trade profile 152 to the server computer system 132. The client computer system 100 receives the transaction data 154 from the server 132, and the transaction data 154 describes the files that are available at other clients that meet the trade profile 152 of the client computer system 100. Example trade profiles are further described below with reference to FIGS. 5A and 5B. Example transaction data 154 is further described below with reference to FIGS. 6A, 6B, and 6C.

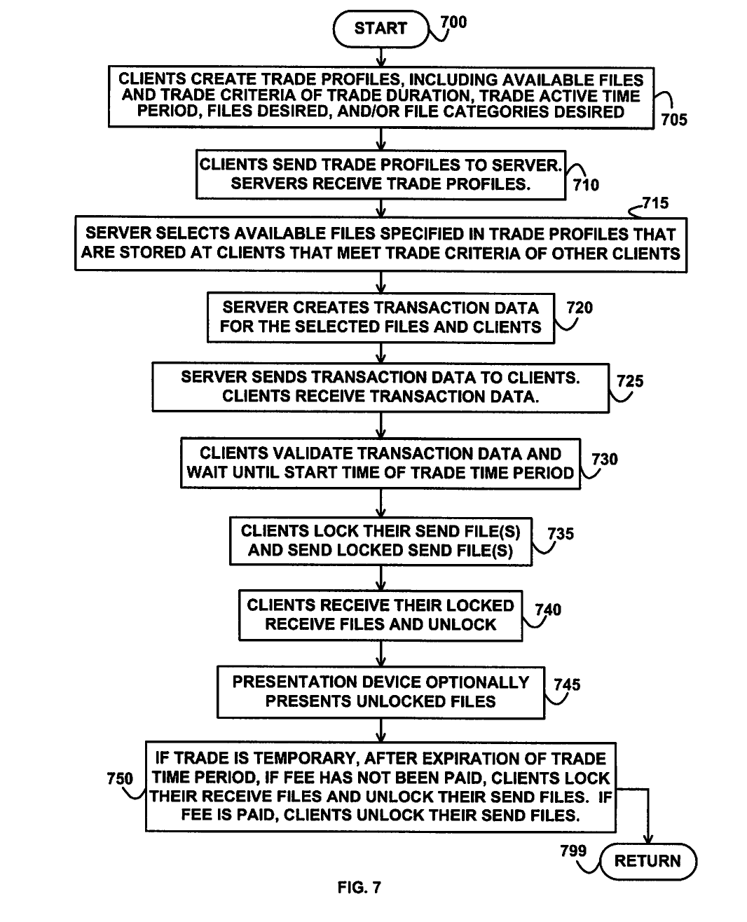

In an embodiment, the controller 156 includes instructions capable of executing on the processor 101 or statements capable of being interpreted by instructions executing on the processor 101 to perform the functions as further described below with reference to FIG. 7. In another embodiment, the controller 156 may be implemented in microcode. In another embodiment, the controller 156 may be implemented in hardware via logic gates and/or other appropriate hardware techniques.

The memory bus 103 provides a data communication path for transferring data among the processor 101, the main memory 102, and the I/O bus interface unit 105. The I/O bus interface unit 105 is further coupled to the system I/O bus 104 for transferring data to and from the various I/O units. The I/O bus interface unit 105 communicates with multiple I/O interface units 111, 112, 113, and 114, which are also known as I/O processors (IOPs) or I/O adapters (IOAs), through the system I/O bus 104. The system I/O bus 104 may be, e.g., an industry standard PCI (Peripheral Component Interface) bus, or any other appropriate bus technology.

The I/O interface units support communication with a variety of storage and I/O devices. For example, the terminal interface unit 111 supports the attachment of one or more user terminals 121. The storage interface unit 112 supports the attachment of one or more direct access storage devices (DASD) 125, 126, and 127 (which are typically rotating magnetic disk drive storage devices, although they could alternatively be other devices, including arrays of disk drives configured to appear as a single large storage device to a host). The contents of the main memory 102 may be stored to and retrieved from the direct access storage devices 125, 126, and 127, as needed.

The I/O device interface 113 provides an interface to any of various other input/output devices or devices of other types. One such device, the presentation device 133, is shown in the exemplary embodiment of FIG. 1, but in other embodiment many other such devices may exist, which may be of differing types. The network interface 114 provides one or more communications paths from the computer system 100 to other digital devices and computer systems; such paths may include, e.g., one or more networks 130.

Although the memory bus 103 is shown in FIG. 1 as a relatively simple, single bus structure providing a direct communication path among the processors 101, the main memory 102, and the I/O bus interface 105, in fact the memory bus 103 may comprise multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 105 and the I/O bus 104 are shown as single respective units, the computer system 100 may in fact contain multiple I/O bus interface units 105 and/or multiple I/O buses 104. While multiple I/O interface units are shown, which separate the system I/O bus 104 from various communications paths running to the various I/O devices, in other embodiments some or all of the I/O devices are connected directly to one or more system I/O buses.

In an embodiment, the computer system 100 may be a multi-user “mainframe” computer system, but embodiments of the invention are not limited to a particular size or type of computer system. The computer system 100 may alternatively be a single-user system, typically containing only a single user display and keyboard input, or might be a server or similar device which has little or no direct user interface, but receives requests from other computer systems (clients). In other embodiments, the computer system 100 may be implemented as a personal computer, portable computer, laptop or notebook computer, PDA (Personal Digital Assistant), tablet computer, pocket computer, music player, video player, telephone, pager, automobile, teleconferencing system, appliance, or any other appropriate type of electronic device.

The network 130 may be any suitable network or combination of networks and may support any appropriate protocol suitable for communication of data and/or code to/from the computer system 100. In various embodiments, the network 130 may represent a storage device or a combination of storage devices, either connected directly or indirectly to the computer system 100. In an embodiment, the network 130 may support the Infiniband architecture. In another embodiment, the network 130 may support wireless communications. In another embodiment, the network 130 may support hard-wired communications, such as a telephone line or cable. In another embodiment, the network 130 may support the Ethernet IEEE (Institute of Electrical and Electronics Engineers) 802.3x specification. In another embodiment, the network 130 may be the Internet and may support IP (Internet Protocol).

In another embodiment, the network 130 may be a local area network (LAN) or a wide area network (WAN). In another embodiment, the network 130 may be a hotspot service provider network. In another embodiment, the network 130 may be an intranet. In another embodiment, the network 130 may be a GPRS (General Packet Radio Service) network. In another embodiment, the network 130 may be a FRS (Family Radio Service) network. In another embodiment, the network 130 may be any appropriate cellular data network or cell-based radio network technology. In another embodiment, the network 130 may be an IEEE 802.11B wireless network. In still another embodiment, the network 130 may be any suitable network or combination of networks. Although one network 130 is shown, in other embodiments any number of networks (of the same or different types) may be present.

The server computer system 132 may include some or all of the hardware components previously described above as being included in the computer system 100. The server computer system 132 includes memory 188 connected to a processor 189. The memory 188, which may be a semiconductor random access memory stores or encodes a trade manager 190 and aggregated profiles 192. The trade manager 190 aggregates trade profiles 152 received from client computer systems 100 into the aggregated profiles 192, creates transaction data 154 based on the aggregated profiles 192, and sends the transaction data 154 to the client computer systems 100.

The trade manager 190 includes instructions capable of executing on the processor 189 or statements capable of being interpreted by instructions executing on the processor 189 to perform the functions as further described below with reference to FIG. 7. In another embodiment, the trade manager 190 may be implemented in microcode. In another embodiment, the trade manager 190 may be implemented in hardware via logic gates and/or other appropriate hardware techniques.

The presentation device 133 is an audio and/or video player. The presentation device 133 includes the files 150 and an output device 198. The presentation device 133 receives the files 150 from the client computer system 100, encodes the files 150 in a storage device, and presents or plays the files 150 via an output device 198, e.g., a speaker and/or a video display. In an embodiment, the presentation device 133 is a mobile device that is capable of being docked to the I/O device interface 113, in order to transfer the files 150, but may then be removed from the client computer system 100. In various embodiments, the presentation device 133 may play, present, or display the files 150 via the output device 198 while docked to the computer system 100 or while removed from the computer system 100.

It should be understood that FIG. 1 is intended to depict the representative major components of the computer system 100, the network 130, the server computer system 132, and the presentation device 133 at a high level, that individual components may have greater complexity than represented in FIG. 1, that components other than or in addition to those shown in FIG. 1 may be present, and that the number, type, and configuration of such components may vary. Several particular examples of such additional complexity or additional variations are disclosed herein; it being understood that these are by way of example only and are not necessarily the only such variations.

The various software components illustrated in FIG. 1 and implementing various embodiments of the invention may be implemented in a number of manners, including using various computer software applications, routines, components, programs, objects, modules, data structures, etc., referred to hereinafter as “computer programs,” or simply “programs.” The computer programs typically comprise one or more instructions that are resident at various times in various memory and storage devices in the client computer system 100 and/or the server computer system 132, and that, when read and executed by one or more processors in the client computer system 100 and/or the server computer system 132, cause the client computer system 100 and/or the server computer system 132 to perform the steps necessary to execute steps or elements comprising the various aspects of an embodiment of the invention.

Moreover, while embodiments of the invention have and hereinafter will be described in the context of fully-functioning computer systems, the various embodiments of the invention are capable of being distributed as a program product in a variety of forms, and the invention applies equally regardless of the particular type of signal-bearing medium used to actually carry out the distribution. The programs defining the functions of this embodiment may be delivered to the client computer system 100 and/or the server computer system 132 via a variety of tangible signal-bearing media that may be operatively or communicatively connected (directly or indirectly) to the processor or processors, such as the processor 101. The signal-bearing media may include, but are not limited to:

(1) information permanently stored on a computer-readable non-rewriteable storage medium, e.g., a read-only memory device attached to or within a computer system, such as a CD-ROM readable by a CD-ROM drive;

(2) alterable information stored on a computer-readable rewriteable storage medium, e.g., a hard disk drive (e.g., DASD 125, 126, or 127), the main memory 102, CD-RW, or diskette; or

(3) information conveyed to the computer system 100 and/or the server computer system 132 by a communications medium, such as through a computer or a telephone network, e.g., the network 130.

Such tangible computer-readable signal-bearing media, when encoded with or carrying computer-readable and executable instructions that direct the functions of the present invention, represent embodiments of the present invention.

Embodiments of the present invention may also be delivered as part of a service engagement with a client corporation, nonprofit organization, government entity, internal organizational structure, or the like. Aspects of these embodiments may include configuring a computer system to perform, and deploying computing services (e.g., computer-readable code, hardware, and web services) that implement, some or all of the methods described herein. Aspects of these embodiments may also include analyzing the client company, creating recommendations responsive to the analysis, generating computer-readable code to implement portions of the recommendations, integrating the computer-readable code into existing processes, computer systems, and computing infrastructure, metering use of the methods and systems described herein, allocating expenses to users, and billing users for their use of these methods and systems.

In addition, various programs described hereinafter may be identified based upon the application for which they are implemented in a specific embodiment of the invention. But, any particular program nomenclature that follows is used merely for convenience, and thus embodiments of the invention should not be limited to use solely in any specific application identified and/or implied by such nomenclature.

The exemplary environments illustrated in FIG. 1 are not intended to limit the present invention. Indeed, other alternative hardware and/or software environments may be used without departing from the scope of the invention.

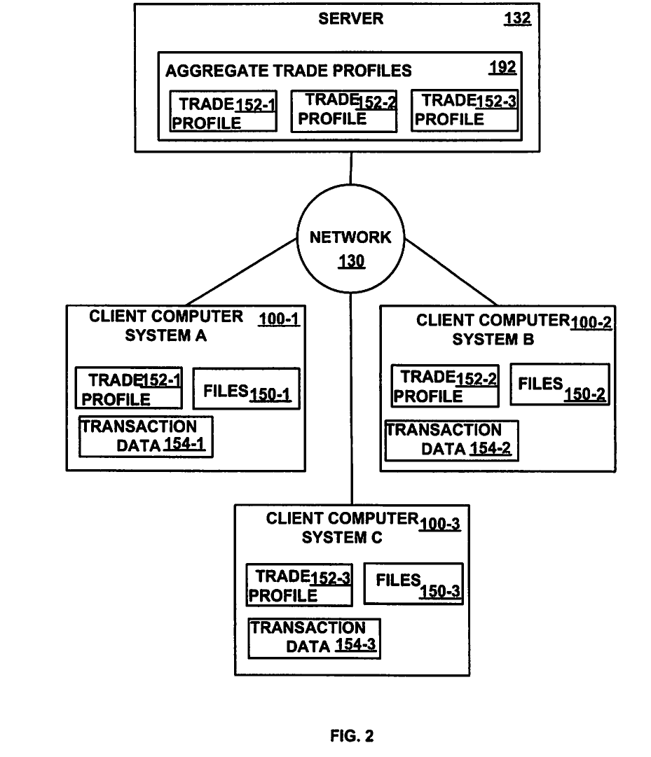

FIG. 2 depicts a high-level block diagram of selected components of the example system, according to an embodiment of the invention. The example system includes the server computer system 132 connected to client computer systems 100-1, 100-2, and 100-3 via the network 130. The computer system 100 (FIG. 1) generically refers to the client computer systems 100-1, 100-2, and 100-3. The client computer system 100-1 includes or stores the trade profile 152-1, the files 150-1, and the transaction data 154-1. The client computer system 100-2 includes or stores the trade profile 152-2, the files 150-2, and the transaction data 154-2. The client computer system 100-3 includes the trade profile 152-3, the files 150-3, and the transaction data 154-3. The trade profile 152 (FIG. 1) generically refers to the trade profiles 152-1, 152-2, and 152-3. The files 150 (FIG. 1) generically refers to the files 150-1, 150-2, and 150-3. The transaction data 154 (FIG. 1) generically refers to the transaction data 154-1, 154-2, and 154-3.

The server computer system 132 includes or stores the aggregate trade profiles 192, which includes the trade profiles 152-1, 152-2, and 152-3, which the server computer system 132 received from the client computer systems 100-1, 100-2, and 100-3. The server 132 creates the transaction data 154-1, 154-2, and 154-3, and sends the transaction data 154-1, 154-2, and 154-3 to the respective client computer systems 100-1, 100-2, and 100-3.

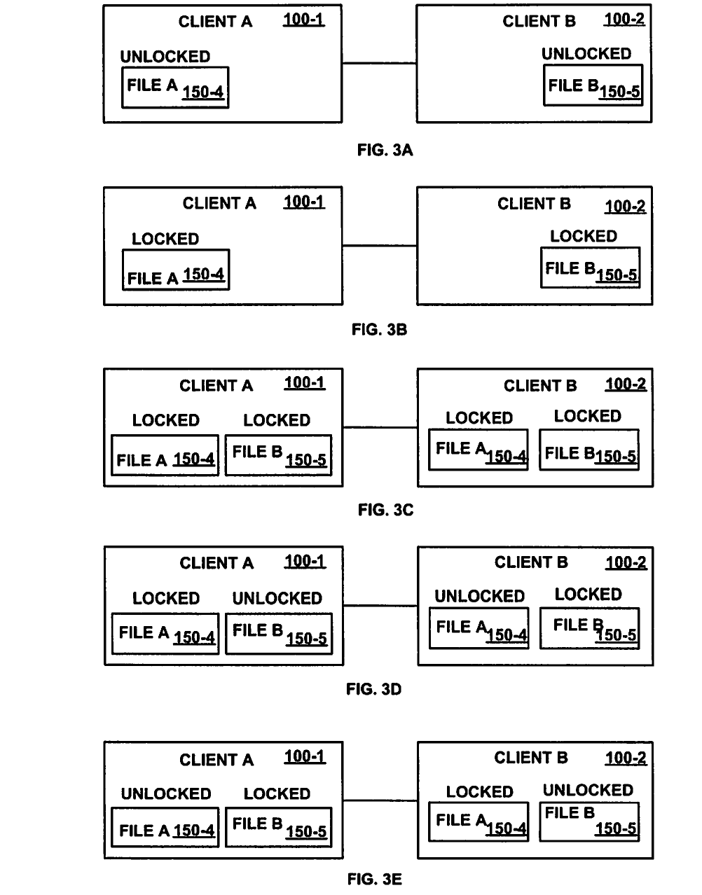

FIGS. 3A, 3B, 3C, 3D, and 3E depict a block diagram of an example trade of files between two client devices 100-1 and 100-2, according to an embodiment of the invention. FIGS. 3A, 3B, 3C, 3D, and 3E are in chronological order, with FIG. 3A representing the earliest time and FIG. 3E representing the most recent time.

FIG. 3A represents the state of the clients 100-1 and 100-2 at the earliest time. The client 100-1 stores the file A 150-4, and the client 100-2 stores the file B 150-5. Both the file A 150-4 and the file B 150-5 have an unlocked status. A file with an unlocked status may be presented, played, displayed or accessed, e.g., via the terminal 121 or the presentation device 133.

The client 100-1 creates a trade profile, which specifies the file 150-4 is available to trade and which specifies a trade criteria, and sends the trade profile to the server 132. The client 100-2 creates a trade profile, which specifies the file 150-5 is available to trade and which specifies a trade criteria, and sends its trade profile to the server 132. The server 132 determines that the trade criteria of the clients 100-1 and 100-2 match or are compatible and that the file 150-4 that is available at the client 100-1 meets the trade criteria of the client 100-2 and that the file 150-5 that is available at the client 100-2 meets the trade criteria of the client 100-1.

The server 132 creates transaction data that describes a trade of the files 150-4 and 150-5 from the perspective of the client 100-1 and sends that transaction data to the client 100-1. The server 132 also creates transaction data that describes the trade of the files 150-4 and 150-5 from the perspective of the client 100-2 and sends that transaction data to the client 100-2.

FIG. 3B represents the state of the clients 100-1 and 100-2 at a time after the time of FIG. 3A. At FIG. 3B, the clients 100-1 and 100-2 receive their respective transaction data and validate that their received transaction data meets their respective trade criteria. The clients 100-1 and 100-2 then wait until the trade start time that is specified by the transaction data. In response to the arrival of the trade start time, the clients 100-1 and 100-2 lock their respective files 150-4 and 150-5 and send their respective files to each other. Locking a file changes the file from having an unlocked status to having a locked status. The locked status prevents presentation, display, play, or access of the file, e.g., via the terminal 121 or the presentation device 133. In various embodiments, the clients may lock the files 150 by encrypting the files, by compressing the files, and/or by restricting access to the files.

FIG. 3C represents the state of the clients 100-1 and 100-2 at a time that is after the time of FIG. 3B. The client 100-1 receives the file 150-5, which has a locked status because the file 150-5 was locked by the client 100-2 before the client 100-2 sent the file 150-5. The client 100-2 receives the file 150-4, which has a locked status because the file 150-4 was locked by the client 100-1 before the client 100-1 sent the file 150-4. Both of the files 150-4 and 150-5 are physically present (both of the clients have a copy of both files) and stored at both of the clients 100-1 and 100-2, and both of the files 150-4 and 150-5 are locked.

FIG. 3D represents the state of the clients 100-1 and 100-2 at a time that is after the time of FIG. 3C. The client 100-1 unlocks the file 150-5. The client 100-2 unlocks the file 150-4. At the client 100-1, the file 150-4 is still locked and the file 150-5 is unlocked. At the client 100-2, the file 150-5 is still locked, and the file 150-4 is unlocked. The clients 100-1 and 100-2 may also send their respective unlocked files 150-5 and 150-4 to their respective presentation devices 133 or terminals 121 for presentation. The clients 100-1 and 100-2 further send a command to their respective presentation devices instructing the presentation devices 133 to delete or lock the respective files 150-5 and 150-4 upon arrival of the trade end time specified by the transaction data 154.

FIG. 3E represents the state of the clients 100-1 and 100-2 at a time that is after the time of FIG. 3D. In response to expiration of the trade time period (the arrival of the trade end time), the client 100-1 locks the file 150-5 and unlocks the file 150-4, and the client 100-2 locks the file 150-4 and unlocks the file 150-5. Both of the files 150-4 and 150-5 are still present and physically stored at the client 100-1, but the file 150-4 is unlocked and the file 150-5 is locked. Both of the files 150-4 and 150-5 are still present and physically stored at the client 100-2, but the file 150-4 is locked and the file 150-5 is unlocked. In another embodiment, the client 100-1 optionally deletes the file 150-5, and the client 100-2 optionally deletes the file 150-4. The presentation devices 133 of the clients 100-1 and 100-2 delete or lock their respective files 150-5 and 150-4 upon arrival of the trade end time.

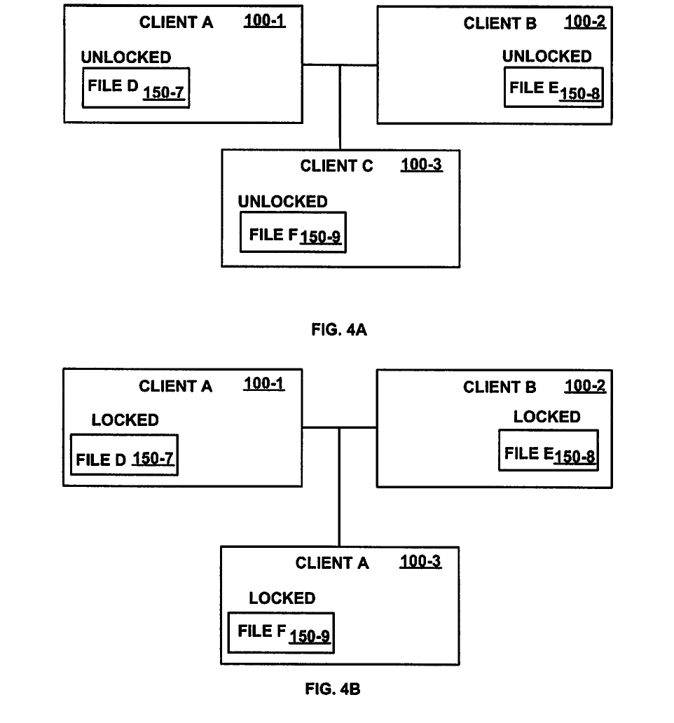

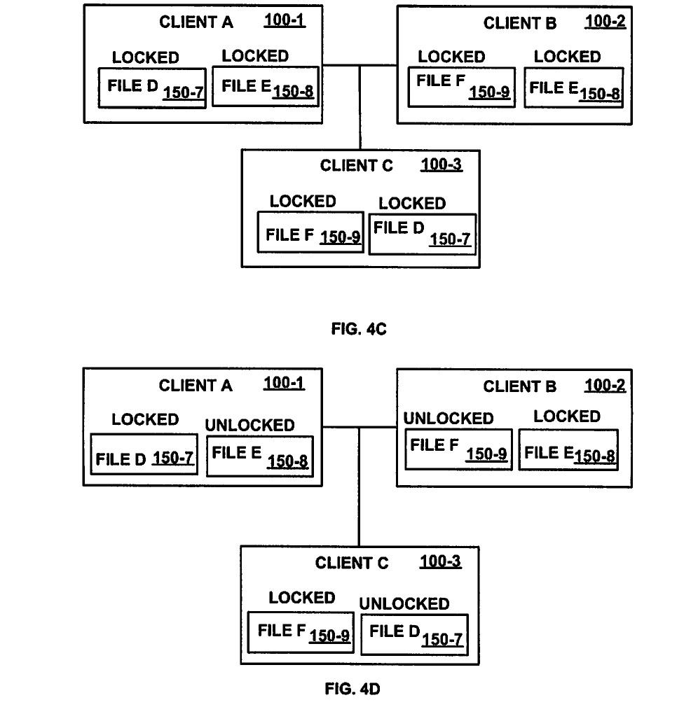

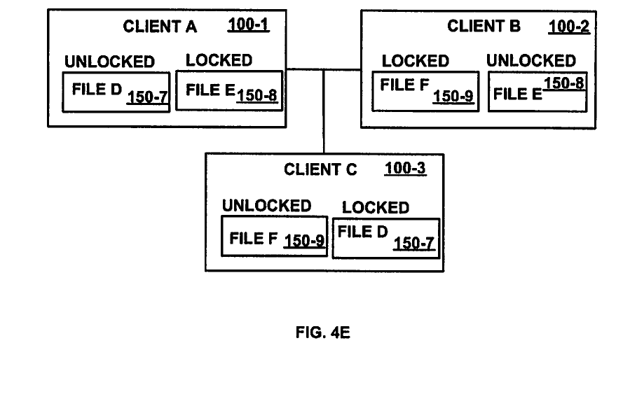

FIGS. 4A, 4B, 4C, 4D, 4D, and 4E depict block diagrams of an example trade of files between three client devices 100-1, 100-2, and 100-3, according to an embodiment of the invention. FIGS. 4A, 4B, 4C, 4D, and 4E are in chronological order, with FIG. 4A representing the earliest time and FIG. 4E representing the most-recent time.

FIG. 4A represents the state of the clients 100-1, 100-2, and 100-3 at the earliest time. The client 100-1 stores the file D 150-7, the client 100-2 stores the file E 150-8, and the client 100-3 stores the file F 150-9. The file D 150-7, the file E 150-8, and the file F 150-9 all have an unlocked status. The client 100-1 creates a trade profile, which specifies the file 150-7 is available to trade and which specifies a trade criteria, and sends the trade profile to the server 132. The client 100-2 creates a trade profile, which specifies the file 150-8 is available to trade and which specifies a trade criteria, and sends its trade profile to the server 132. The client 100-3 creates a trade profile, which specifies the file 150-9 is available to trade and which specifies a trade criteria, and sends its trade profile to the server 132.

The server 132 determines that the trade criteria of the clients 100-1, 100-2, and 100-3 are compatible and that the file 150-7 that is available at the client 100-1 meets the trade criteria of the client 100-3, that the file 150-8 that is available at the client 100-2 meets the trade criteria of the client 100-1, and that the file 150-9 that is available at the client 100-3 meets the trade criteria of the client 100-2. The server 132 creates transaction data that describes a trade from the perspective of the client 100-1 and sends that transaction data to the client 100-1. The server 132 also creates transaction data that describes a trade from the perspective of the client 100-2 and sends that transaction data to the client 100-2. The server 132 also creates transaction data that describes a trade from the perspective of the client 100-3 and sends that transaction data to the client 100-3.

FIG. 4B represents the state of the clients 100-1, 100-2, and 100-3 at a time after the time of FIG. 4A. At FIG. 4B, the clients 100-1, 100-2, and 100-3 receive their respective transaction data and validate that their received transaction data meets their respective trade criteria. The clients 100-1, 100-2, and 100-3 then wait until the trade start time that is specified by their transaction data. In response to the arrival of the trade start time, the clients 100-1, 100-2, and 100-3 lock their respective files 150-7, 150-8, and 150-9. The client 100-1 sends the locked file 150-7 to the client 100-3. The client 100-3 sends the locked file 150-9 to the client 100-2, and the client 100-2 sends the locked file 150-8 to the client 100-1.

FIG. 4C represents the state of the clients 100-1, 100-2, and 100-3 at a time that is after the time of FIG. 4B. The client 100-1 receives the file 150-8, which has a locked status because the file 150-8 was locked by the client 100-2 before the client 100-2 sent the file 150-8. The client 100-2 receives the file 150-9, which has a locked status because the file 150-9 was locked by the client 100-3 before the client 100-3 sent the file 150-9. The client 100-3 receives the file 150-7, which has a locked status because the file 150-7 was locked by the client 100-1 before the client 100-1 sent the file 150-7.

FIG. 4D represents the state of the clients 100-1, 100-2, and 100-3 at a time that is after the time of FIG. 4C. The client 100-1 unlocks the file 150-8. The client 100-2 unlocks the file 150-9. The client 100-3 unlocks the file 150-7. At the client 100-2, the file 150-7 is still locked and the file 150-8 is unlocked. At the client 100-2, the file 150-8 is still locked, and the file 150-9 is unlocked. At the client 100-3, the file 150-9 is still locked, and the file 150-7 is unlocked. The clients 100-1, 100-2, and 100-3 may also send their respective unlocked files 150-8, 150-9, and 150-7 to their respective presentation devices 133 and/or terminals 121 for presentation. The clients 100-1, 100-2, and 100-3 further send a command to their respective presentation devices 133 instructing the presentation devices 133 to delete or lock the respective files 150-8, 150-9, and 150-7 upon arrival of the trade end time specified by the transaction data 154.

FIG. 4E represents the state of the clients 100-1, 100-2, and 100-3 at a time that is after the time of FIG. 4D. In response to expiration of the trade time period (the arrival of the trade end time specified by the transaction data), the client 100-1 locks the file 150-8 and unlocks the file 150-7, the client 100-2 locks the file 150-9 and unlocks the file 150-8, and the client 100-3 locks the file 150-7 and unlocks the file 150-9. Both of the files 150-7 and 150-8 are still present and physically stored at the client 100-1, but the file 150-7 is unlocked and the file 150-8 is locked. Both of the files 150-8 and 150-9 are still present and physically stored at the client 100-2, but the file 150-8 is unlocked and the file 150-9 is locked. Both of the files 150-7 and 150-9 are still present and physically stored at the client 100-3, but the file 150-7 is locked and the file 150-9 is unlocked. In another embodiment, the client 100-1 optionally deletes the file 150-8, the client 100-2 optionally deletes the file 150-9, and the client 100-3 optionally deletes the file 150-7. The presentation devices 133 of the clients 100-1, 100-2, and 100-3 delete or lock their respective files 150-8, 150-9, and 150-7 upon arrival of the trade end time.

FIG. 5A depicts a block diagram of an example data structure for a trade profile 152-1, according to an embodiment of the invention. The trade profile 152 (FIG. 1) generically refers to the trade profile 152-1. The client 100-1 creates the trade profile 152-1. The trade profile 152-1 specifies files that are available to trade at the client 100-1 and criteria for trading the available files.

The trade profile 152-1 includes a trade criteria of a trade minimum duration 505, a trade maximum duration 510, and a trading active time period 515. The trade minimum duration 505 specifies the minimum amount of time for which the client 100-1 is willing to trade its available files. The trade maximum duration 510 specifies the maximum amount of time for which the client 100-1 is willing to trade its available files. The trading active time period 515 specifies the dates and/or times during which the client 100-1 is willing to trade its available files. The trading active period 515 may specify times of day, specific dates, or days of the week on which the client 100-1 is willing to trade its available files. In another embodiment, the trading active period 515 may exclude times of day, dates, or days of the week on which the client 100-1 is not willing to trade its available files.

The trade profile 152-1 further includes records 520, 525, and 530 each of which includes a file identifier field 535, a file category field 540, and a status field 545. The file identifier field 535 in the trade profile 152-1 specifies the files 150 that are either stored at the client 100-1 and are available to trade or files that the client 100-1 desires to receive in trade, based on the value in the status field 545. The file category field 540 specifies a category to which a file belongs. In an embodiment, the file category 540 specifies the author, writer, composer, owner, distributor, producer, or director of the content of the file. In another embodiment, the category 540 specifies the performer, actor, musician, or singer whose performance is recorded in the content of the file. In another embodiment, the category 540 specifies the styles, types, or genres that characterize or describe the content of the files. In another embodiment, the file category field 540 specifies any multiple or combination of categories.

The status field 545 in the trade profile 152-1 specifies the purpose of the record 520, 525, or 530. A record 520 with a status 545 of available indicates that the files 535 and/or file categories 540 are available at the client 100-1 for trade. A record 525 or 530 with a status 545 of desired indicates that the files 535 and/or file categories 540 are not available at the client 100-1, but instead the client 100-1 desires to receive the files 535 and/or files that belong to the file categories 540. A record 525 or 530 with a status 545 of desired specifies a trade criteria.

In an embodiment, the file identifier field 535 is optional, or if present may have no data supplied by the client 100-1. If the file identifier field 535 is not present or has no data specified and the status 545 indicates the record represents desired files, then the client 100-1 desires any file having or belonging to the specified category 540. In an embodiment, the file category field 540 is optional, or if present may have no data supplied by the client 100-1. If the file category field 540 is not present or has no data specified, and the status 545 indicates that the record represents available files 535, then the client 100-1 has not supplied the category to which the file 535 belongs, and the server 132 may supply a category for the files 535.

As illustrated in the record 520, the files A, D, and M are available at the client A 100-1. The files A and D in the record 520 correspond to the trade examples of FIG. 3A and FIG. 4A. As illustrated in the record 525, the client A 100-1 desires to receive the file E specified by the file identifier 535, which corresponds to the trade example of FIGS. 4A, 4B, 4C, 4D, and 4E. As illustrated in the record 530, the client 100-1 desires any files that belong to a file category 540 of “type F.” As will be further explained below with respect to FIG. 5B, the file B 150-5 (FIGS. 3A, 3B, 3C, 3D, and 3E) belongs to the “type F” category.

FIG. 5B depicts a block diagram of an example data structure for a trade profile 152-2, according to an embodiment of the invention. The trade profile 152 (FIG. 1) generically refers to the trade profile 152-2. The client 100-2 creates the trade profile 152-2. The trade profile 152-2 includes a trade minimum duration 505, a trade maximum duration 510, and a trading active time period 515. The trade minimum duration 505 in the trade profile 152-2 specifies the minimum amount of time for which the client 100-2 is willing to trade files. The trade maximum duration 510 in the trade profile 152-2 specifies the maximum amount of time for which the client 100-2 is willing to trade files. The trading active time period 515 in the trade profile 152-2 specifies the dates and/or times during which the client 100-2 is willing to trade files.

The trade profile 152-2 further includes records 550, 555, and 560, each of which includes a file identifier field 535, a file category field 540, and a status field 545. The file identifier field 535 in the trade profile 152-2 specifies files that are either stored at the client 100-2 and are available to trade or files that the client 100-2 desires to receive in trade, based on the value in the status field 545.

The status field 545 in the trade profile 152-2 specifies the purpose of the record. A record 550 with a status 545 of available indicates that the files 535 and/or file categories 540 are available at the client 100-2 for trade. A record 555 or 560 with a status 545 of desired indicates that the files 535 and/or file categories 540 are not available at the client 100-2, but instead the client 100-2 desires to receive the files 535 and/or files 150 that belong to the file category 540.

As illustrated in the record 550, the files B and E are available at the client B 100-2, which, which corresponds to the examples of FIG. 3A and FIG. 4A. As further illustrated in the record 550, the file B has a file category 540 of type F. Since the client 100-1 desires files 150 that have a file category of type F (illustrated in record 530 of FIG. 5A), the server 132 selects the available file B in record 550 as meeting the trade criteria of the client 100-1, as specified by the record 530 in the trade profile 152-1.

As illustrated in the record 555, the client B 100-2 desires to receive the file A specified by the file identifier 535, which corresponds to the trade example of FIGS. 3A, 3B, 3C, 3D, and 3E. Since the file A is available at the client 100-1, as specified by the record 520 in the trade profile 152-1 of FIG. 5A, the server 132 selects the available file A from record 520 as meeting the trade criteria of the client 100-2, as specified by the record 555 in the trade profile 152-2 of FIG. 5B.

FIG. 6A depicts a block diagram of an example data structure for transaction data 154-1, according to an embodiment of the invention. The transaction data 154-1 specifies a request for a trade(s) from the perspective of the client 100-1, which receives the transaction data 154-1 from the server 132 and performs the trading of file(s) specified by the transaction data 154-1. The server 132 created the transaction data 154-1 in response to receiving trade profiles 152 from the clients 100 and selecting the files 150 and clients 100 that met the trade criteria specified in the trade profiles 152. The other client(s) involved in the trade receive their own transaction data that reflects the trade(s) from their perspective, as further described below with reference to FIGS. 6B and 6C.

The transaction data 154-1 includes records 605 and 610, each of which includes a send file field 615, a receive file field 620, a trade time period field 625, a receive client field 630, a send client field 635, and a lock field 640. The example data in the record 605 corresponds to the example of FIGS. 3A, 3B, 3C, 3D, and 3E. The example data in the record 610 corresponds to the example of FIGS. 4A, 4B, 4C, 4D, and 4E.

The send file 615 in the transaction data 154-1 specifies a file that is stored at the client 100-1 and that is available to be traded or exchanged by the client 100-1. The receive file 620 in the transaction data 154-1 specifies a file that the client 100-1 is to receive in trade for the send file 615. The trade time period field 625 in the transaction data 154-1 specifies a period of time during which the client 100-1 is allowed to unlock the receive file 620 and present the receive file 620 at the client 100-1 or at the presentation device 133. The trade time period 625 specifies a trade start time and a trade end time that delineate the trade time period 625. The server selects or determines the trade time period 625 to be within the trading active time period 515 of all of the clients involved in the trade and selects the duration of the trade time period 625 to be greater than the trade minimum duration 505 and less than the trade maximum duration 510 of all of the clients involved in the trade.

The receive client field 630 in the transaction data 154-1 specifies the client from which the client 100-1 is to receive the receive file 620. The send client field 635 in the transaction data 154-1 specifies the client to which the client 100-1 is to send the send file 615. In an embodiment, the receive client 630 and the send client 635 may identify the same client, which the record 605 illustrates, corresponding to the example of FIGS. 3A, 3B, 3C, 3D, and 3E. In another embodiment, the receive client 630 and the send client 635 may identify different clients, which the record 610 illustrates, corresponding to the example of FIGS. 4A, 4B, 4C, 4D, and 4E.

The lock field 640 in the transaction data 154-1 instructs the client 100-1 whether or not to lock the send file 615 and receive file 620. Locking a file changes the file from having an unlocked status to having a locked status. A locked status prevents presentation, display, play, or access of the file, e.g., via the terminal 121 or the presentation device 133. Unlocking a file changes the file from a locked status to an unlocked status and allows presentation, display, or access of the file, e.g., via the terminal 121 or the presentation device 133. In various embodiments, the clients may lock the files by encrypting the files, by compressing the files, and/or by restricting access to the files.

In response to receiving the transaction data 154-1 from the server 132, the client 100-1 validates the transaction data 154-1 and determines that the transaction data 154-1 meets the trade profile 152-1. For example, the client 100-1 determines whether the send file 615 specified by the transaction data 154-1 is available at the client 100-1, determines whether the receive 620 is desired by the client 100-1 as specified by the trade criteria of the trade profile 152-1, determines whether the trade time period 625 is within the trading active time period 515 of the trade profile 152-1, and determines whether the duration of the trade time period 625 is greater than or equal to (at least as large as) the trade minimum duration 505 and less than or equal to (at least as small as) the trade maximum duration 510 specified by the trade profile 152-1. The client 100-1 also determines whether the lock field 640 in the transaction data 154-1 requires the files 615 and 620 to be locked.

In response to the arrival of the trade start time (the current time is after the trade start time but before the trade end time), the client 100-1 locks the send file 615 (if required by the lock field 640), and sends the send file 615 to the send client 635. The client 100-1 receives the receive file 620 (which is locked if so indicated by the lock field 640) from the receive client 630. The client 100-1 unlocks the receive file 620, and optionally sends the receive file 620 to the presentation device 133 or the terminal 121, which may present, play, or display the receive file 620. The client 100-1 further sends a trade command to the presentation device 133, an identification of the send file 615, and the trade end time 625. In response to the lock command, the presentation device 133 searches for the send file 615, and if the send file 615 is found at the presentation device 133, the presentation device 133 locks the send file 615. After determining that the trade time period 625 has expired (determining that the current time is later than the trade end time), the client 100-1 locks the receive file 620 and unlocks the send file 615. In response to the trade command, after determining that the trade time period 625 has expired (determining that the current time is later than the trade end time), the presentation device 133 locks or deletes the receive file 620 and unlocks the send file 615.

FIG. 6B depicts a block diagram of an example data structure for the transaction data 154-2, according to an embodiment of the invention. The transaction data 154-2 specifies a request for a trade(s) from the perspective of the client 100-2, which receives the transaction data 154-2 from the server 132 and performs the trading of file(s) specified by the transaction data 154-2.

The transaction data 154-2 includes records 645 and 650, each of which includes a send file field 615, a receive file field 620, a trade time period field 625, a receive client field 630, a send client field 635, and a lock field 640. The example data in the record 645 corresponds to the example of FIGS. 3A, 3B, 3C, 3D, and 3E. The example data in the record 650 corresponds to the example of FIGS. 4A, 4B, 4C, 4D, and 4E.

FIG. 6C depicts a block diagram of an example data structure for transaction data 154-3, according to an embodiment of the invention. The transaction data 154-3 specifies a request for a trade(s) from the perspective of the client 100-3, which receives the transaction data 154-3 from the server 132 and performs the trading of file(s) specified by the transaction data 154-3.

The transaction data 154-3 includes a record 655, which includes a send file field 615, a receive file field 620, a trade time period field 625, a receive client field 630, a send client field 635, and a lock field 640. The example data in the record 655 corresponds to the example of FIGS. 4A, 4B, 4C, 4D, and 4E.

FIG. 7 depicts a flowchart of example processing for trading files, according to an embodiment of the invention. Control begins at block 700. Control then continues to block 705 where the clients 100 create their trade profiles 152, including specifications of their available files 150 and their trade criteria of trade minimum duration 505, trade maximum duration 510, trading active time period 515, the files desired, and/or the file categories desired.

Control then continues to block 710 where the clients 100 send their trade profiles 152 to the server 132 and the server 132 receives and aggregates the trade profiles. Control then continues to block 715 where the server 132 selects the available files specified in the trade profiles 152 that are stored at the clients that meet or are compatible with the trade criteria of other clients and determines that the trade criteria of the clients are compatible. In various embodiments, the server 132 determines that an available file at a client meets a trade criteria of another client by determining that an available file is specified by the trade criteria of another client or by determining that an available file belongs to, or is associated with, a category specified in the trade criteria of another client.

In an embodiment, in order to determine that the trade criteria of the clients 100-1 and 100-2 match or are compatible, the server 132 determines that the trade maximum duration 510 of the client 100-1 is greater than the trade minimum duration 505 of the client 100-2; determines that the trade maximum duration 510 of the client 100-2 is greater than the trade minimum duration 505 of the client 100-1; determines that the trading active time periods 515 of the clients 100-1 and 100-2 overlap (the intersection of the trading active time periods 515 is a non-zero time period); and determines that the duration of the intersection of the trading active time periods 515 of the clients 100-1 and 100-2 is greater than both of the trade minimum durations 505 of the clients 100-1 and 100-2. In another embodiment, the server 132 may determine that the trade criteria of any number of clients are compatible, such as in the example of FIGS. 4A, 4B, 4C, 4D, and 4E. In an embodiment, the server 132 may determine the value of each file involved in the trade, and a client or the server 132 may require that more than one file be received in exchange for providing a particular file in trade. That is, files may have different exchange values depending on supply and demand for the files or other factors. Also, the server 132 may require one or more of the clients involved in the trade to pay a fee to the server 132, in order to participate in the trade.

Control then continues to block 720 where the server 132 creates the transaction data 154 for the selected files and the clients. Control then continues to block 725 where the server 132 sends the transaction data 154 to the clients. The clients 100 receive the transaction data 154. Control then continues to block 730 where the clients 100 validate their transaction data 154 and wait until the trade start time of the trade time period 625. In an embodiment, as part of the validation process, the clients only proceed with a trade of files if they are in communication with their presentation device 133 (e.g., the presentation device 133 is docked to the client 100 or is capable of wireless communication), in the scenario where their send file 615 is stored at their respective presentation device 133. Only proceeding with the trade if the client 100 is in communication with the presentation device 133 ensures that the copy of the send file 615 (if any) that exists at the presentation device is locked and not capable of presentation during the trade time period 625.

If the clients 100 determine that their respective transaction data 154 is valid, control then continues to block 735 where the clients 100 lock their send file(s) (including locking any copy of the send file that may exist at the presentation device 133 or any other location) and send the locked send file(s) to the send client 635 specified by their respective transaction data 154. Control then continues to block 740 where the clients 100 receive their respective locked receive file(s) 620 from their respective receive clients 630 and unlock their respective receive files 620.

Control then continues to block 745 where the clients optionally send their receive files 620 and trade commands to their presentation devices 133. The trade command identifies the send file 615 and the trade time period 625, including the trade end time. The presentation device 133 receives the receive file 620 and the trade command and determines if the send file 615 exists at the presentation device 133. If the send file 615 exists at the presentation device 133, the presentation device 133 locks the send file 615 at the presentation device 133 and optionally presents the receive file 620.

Control then continues to block 750 where the clients determine whether the trade is temporary (whether a trade end time is specified in the record of the transaction data 154 associated with the trade). The clients further determine if a fee has been paid to the server 132, copyright owner, publisher, or another organization. If the trade is temporary, the fee has not been paid, and the current time meets or is after the trade end time (the trade time period 625 has expired), then upon expiration of the trade time period 625, the client 100 and the presentation device 133 delete the receive file 620 or lock the receive file 620. If a fee has been paid, then the client 100 and the presentation device 133 unlock their copies of the send files 615, and the receive files 620 remain unlocked. If the fee has not been paid, but the trade is permanent (the trade end time is not specified), then the receive file 620 remains unlocked and the send file 615 remains locked or is optionally deleted. The server 132 may determine the fee based on the value of the files that are traded, or based on any other factor.

Control then continues to block 799 where the logic of FIG. 7 returns.

In the previous detailed description of exemplary embodiments of the invention, reference was made to the accompanying drawings (where like numbers represent like elements), which form a part hereof, and in which is shown by way of illustration specific exemplary embodiments in which the invention may be practiced. These embodiments were described in sufficient detail to enable those skilled in the art to practice the invention, but other embodiments may be utilized and logical, mechanical, electrical, and other changes may be made without departing from the scope of the present invention. In the previous description, numerous specific details were set forth to provide a thorough understanding of embodiments of the invention. But, the invention may be practiced without these specific details. In other instances, well-known circuits, structures, and techniques have not been shown in detail in order not to obscure the invention.

Different instances of the word “embodiment” as used within this specification do not necessarily refer to the same embodiment, but they may. Any data and data structures illustrated or described herein are examples only, and in other embodiments, different amounts of data, types of data, fields, numbers and types of fields, field names, numbers and types of rows, records, entries, or organizations of data may be used. In addition, any data may be combined with logic, so that a separate data structure is not necessary. The previous detailed description is, therefore, not to be taken in a limiting sense, and the scope of the present invention is defined only by the appended claims.

What is claimed is:

1. A method comprising:
receiving transaction data that comprises a specification of a first file, a second file, and a first client;
locking the second file, wherein the locking prevents presentation of the second file;
after the locking the second file, transmitting the second file to the first client;
receiving the first file, wherein the first file has a locked status, and wherein the locked status prevents presentation of the first file; and
unlocking the first file, wherein the unlocking allows presentation of the first file.

2. The method of claim 1, further comprising:
after expiration of a time period since the unlocking the first file, locking the first file and unlocking the second file, wherein the locking the first file prevents presentation of the first file, and wherein the unlocking the second file allows presentation of the second file.

3. The method of claim 1, wherein the transaction data comprises a specification of the time period.

4. The method of claim 1, further comprising:
if a fee has been paid, unlocking the second file, wherein the unlocking the second file allows presentation of the second file.

5. The method of claim 1, further comprising:
sending a trade command and the first file to a presentation device, wherein the presentation device presents the first file, determines if a copy of the second file exits at the presentation device, and locks the copy of the second file if the copy exists.

6. The method of claim 3, further comprising:
creating a trade profile that specifies the second file is available to trade and that specifies a trade criteria; and
sending the trade profile to a server, wherein the transaction data is received from the server.

7. The method of claim 6, wherein the creating further comprises:
creating the trade criteria that specifies the first file.

8. The method of claim 6, wherein the creating further comprises:
creating the trade criteria that specifies a category, wherein the server determines that the first file is in the category.

9. The method of claim 6, wherein the creating further comprises:
creating the trade criteria that specifies a trading active period, wherein the server determines that time period is within the trading active period.

10. The method of claim 1, wherein the receiving the first file further comprises:
receiving the first file from the first client.

11. The method of claim 1, wherein the receiving the first file further comprises:
receiving the first file from a second client that is different than the first client.

12. A storage medium encoded with instructions, wherein the instructions when executed on a processor comprise:
receiving a plurality of trade profiles from a plurality of clients, wherein each of the plurality of trade profiles specifies an available file stored at a respective client, and wherein each of the plurality of trade profiles specifies a trade criteria of the respective client;
selecting a first available file that meets a second trade criteria of a second client, wherein the first available file is stored at a first client;
selecting a second available file that meets a first trade criteria of the first client, wherein the second available file is stored at the second client;
sending a specification of the first file and a start time to the first client, wherein in response to arrival of the start time, the first client locks the first file and transmits the first file to the second client; and
sending a specification of the second file and the start time to the second client, wherein in response to arrival of the start time, the second client locks the second file and transmits the second file to the first client.

13. The storage medium of claim 12, wherein the first trade criteria further specifies a first minimum trade duration, a first maximum trade duration, and a first trading active time period, and wherein the second trade criteria further specifies a second minimum trade duration, a second maximum trade duration, and a second trading active time period.

14. The storage medium of claim 13, further comprising:
determining that the first maximum trade duration is greater than the second minimum trade duration;
determining that the second maximum trade duration is greater than the first minimum trade duration; and
determining that a duration of an intersection of the first trading active time period and the second trading active time period is greater than the first minimum trade duration and is greater than the second minimum trade duration

15. The storage medium of claim 12, wherein in the second client receives and unlocks the first file, and wherein the first client receives and unlocks the second file.

16. The storage medium of claim 15, further comprising:
sending a specification of an end time to the first client and the second client, wherein in response to a current time meeting the end time, the second client locks the first file and the first client locks the second file.

17. A computer system comprising:
a processor; and
memory connected to the processor, wherein the memory encodes a second file and further encodes instructions that when executed by the processor comprise:
sending a trade profile to a server, wherein the trade profile specifies that the second file is available to trade and specifies a trade criteria,
receiving from the server a specification of a first file, the second file, a start time, an end time, and a first client,
in response to arrival of the start time, locking the second file, wherein the locking prevents presentation of the second file,
after the locking the second file, transmitting the second file to the first client,
receiving the first file, wherein the first file has a locked status, and wherein the locked status prevents presentation of the first file, and
unlocking the first file, wherein the unlocking allows presentation of the first file.

18. The computer system of claim 17, wherein the instructions further comprise:
in response to a current time meeting the end time, locking the first file and unlocking the second file, wherein the locking the first file prevents presentation of the first file, and wherein the unlocking the second file allows presentation of the second file.

19. The computer system of claim 17, wherein the instructions further comprise:
if a fee has been paid, unlocking the second file, wherein the unlocking the second file allows presentation of the second file.

20. The computer system of claim 17, wherein the instructions further comprise:
in response to the unlocking the first file sending a trade command and the first file to a presentation device, wherein the presentation device presents the first file, determines if a copy of the second file exits at the presentation device, and locks the copy of the second file if the copy exists.
